(19) United States
(12) Patent Application Publication
(10) Pub. No.: US 2006/0232677 A1
(43) Pub. Date: Oct. 19, 2006

(54) Video surveillance data network

(75) Inventors: Vikas H. Butaney, Los Altos, CA (US); Sunny Mahant, San Francisco, CA (US); Todd Marcus Baker, Los Altos, CA (US); Jennifer K. Lin, Los Altos, CA (US)

Correspondence Address: MARGER JOHNSON & MCCOLLOM, P.C., 210 SW MORRISON STREET, SUITE 400, PORTLAND, OR, 97204, US

(73) Assignee: Cisco Technology, Inc., San Jose, CA (US)

(21) Appl. No.: 11/109,198

(22) Filed: Apr. 18, 2005

(51) Int. Cl. H04N 9/04; H04N 5/225

(52) U.S. Cl. 348/207.1; 348/207.99

(57) ABSTRACT

A network device has a first interface to allow communication with at least one network-capable camera and a second interface to allow communication with a network. A processor allows the device to receive video data from the network-capable camera receive commands for the cameras from the network and communicate them from the network. The network device may also have a video encoder to allow network-incapable cameras to communicate across the network. A method of managing a video surveillance data network receives data from a network-capable camera and registers the camera with a network management device. An identification number for the camera is provided and video data from the camera is transmitted across a network. Requests for communication with the camera are screened to only allow authorized users to access data from the camera.

### BACKGROUND

The telecommunications industry has demonstrated that voice and data can be successfully transported over a data network, such as an Internet Protocol (IP) network. The evolution of this technology has allowed traditional, public switched telephone network (PSTN) equipment, such as traditional phones and lines, to access the data network through gateways. Meanwhile, more advanced end points are becoming available, allowing the end point to access the network directly in the native format of the network, such as an IP phone that captures audio voice signals, transcodes it into digital signals, packetizes it according to the appropriate protocol and transmits it directly onto the network.

Similar to telecommunications managers prior to this integration of data and voice networks, security and facility managers build separate video surveillance (VS) networks using co-axial (coax) cables to transport video to monitors and video recorders. Recently, the traditional tape video recorders have begun to be replaced with digital video recorders that digitize the video stream and store it on hard disks and other digital media. In addition to the overhead of having a separate network to maintain, typically security managers have to have personnel assigned to monitor the feeds from the cameras as well personnel to move about the facility, for either security or maintenance reasons.

The ability to monitor the video feeds in a mobile fashion, as well as eliminate the extra network, would provide VS network managers cost savings while increasing effectiveness of their employees.

### SUMMARY

One embodiment is a network device. The device has a first interface to allow communication with at least one network-capable camera, and a second interface to allow communication with a network. A video encoder may also provide an interface to network-incapable cameras. A processor allows the device to receive video data from the network-capable camera and any network-incapable cameras communicate the video data to a network, receive commands for the cameras from the network and communicate them from the network.

Another embodiment is a method of managing a video surveillance data network. The method receives data from a network-capable camera and registers the camera with a network management device. An identification number for the camera is provided and video data from the camera is transmitted across a network. Requests for communication with the camera are screened to only allow authorized users to access data from the camera.

### BRIEF DESCRIPTION OF THE DRAWINGS

Embodiments of the invention may be best understood by reading the disclosure with reference to the drawings, wherein:

FIG. 1 shows a conventional video surveillance apparatus.

FIG. 2 shows a second example of a conventional video surveillance network.

FIG. 3 shows an embodiment of a video surveillance network including a video network device.

FIG. 4 shows a flowchart of an embodiment of a method to manage a video surveillance network as a data network.

### DETAILED DESCRIPTION OF THE EMBODIMENTS

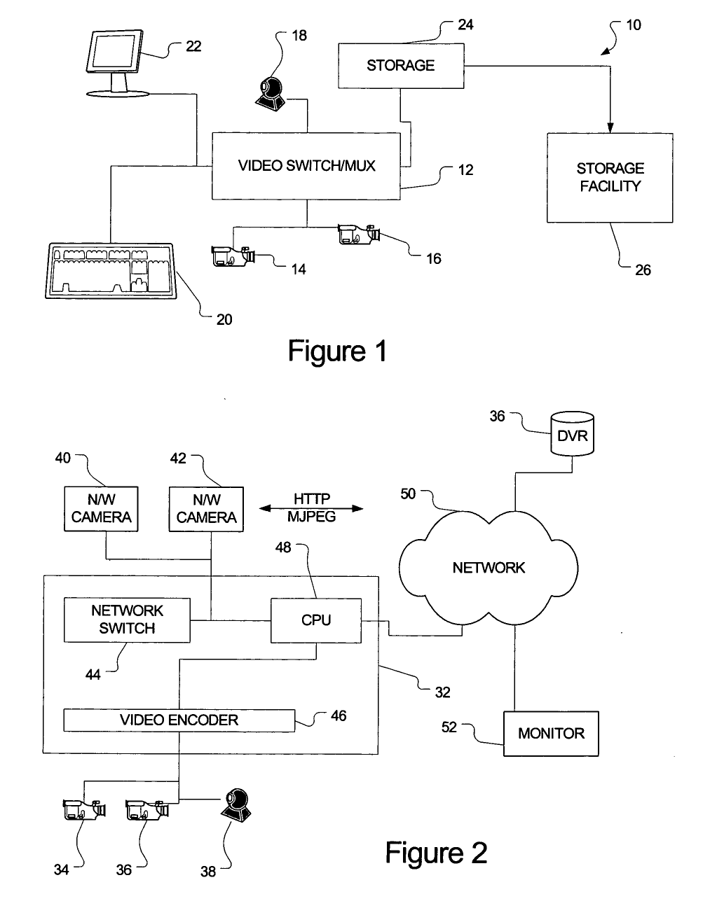

FIG. 1 shows a conventional video surveillance network 10. The network typically includes a video switch/multiplexer 12 that receives images from the cameras such as 14 and 16, which are analog cameras, and 18, which may be a digital camera with pan-tilt-zoom (PTZ) capability. The PTZ camera may be controlled by a PTZ keyboard or controller 20. The network also includes at least one monitor 22 to allow the images on the camera to be viewed, and some sort of storage 24. Generally, the storage is some sort of taping device, having from one to many tapes to record the video feeds from the cameras. The interconnections in this network are coax cables and are redundant of many portions of a data network within the same entity, such as a facility or a business that uses the surveillance network.

Typically, the tapes are either shipped or transported to a storage facility to allow for storage of a particular number of tapes, as well as freeing up space in the local facility. Alternatively, users may record a certain number of days, weeks or hours on a tape and store it for a particular length of time, and then record over it. In either case, the storage has been problematic.

Recently, in newer embodiments of the video surveillance networks, the cumbersome taping procedures have been replaced with digital video recorders (DVRs). DVRs typically employ a ‘solid-state’ memory such as a computer hard disk, taking the images, digitizing them as necessary and storing them on the hard disk of the DVR. The increased capacity of the hard disks and their increased density require less storage space and fewer problems with transporting. An alternative embodiment of a conventional video surveillance network is shown in FIG. 2.

In FIG. 2, the network has a video switch 32 that will generally include a network switch 44, such as a local-area network (LAN) card, Ethernet card, etc. A video encoder 46 encodes the images received from the analog cameras 34 and 36 and the PTZ camera 38. The video switch 32 may also include a processor 48 that allows the video switch to communicate with the network 50 and provide the data in the proper format for the network.

In addition, the network 30 includes network-capable cameras 40 and 42. A network-capable camera, as that term is used here, is a camera that can communicate across a network 50 in a particular protocol, as well as receive commands for configuration and operation across the network as well. The analog and PTZ cameras are network-incapable in that they cannot communicate across the network themselves. With the addition of a video encoder, however, they become network-capable cameras. The network-capable cameras are simple devices that offer an interface for configuration and streaming video across the network to a DVR such as 36, and video monitors such as 52. This network may be interconnected with both coax cables and data network cables, to support both the ‘legacy’ systems such as the analog cameras and the network-capable cameras.

The network-capable cameras generally transport the video images using some transport protocol, such as Text Control Protocol (TCP) in an IP network, typically using JPEG (Joint Photographic Experts Group). Streamed JPEG images may be referred to as MJPEG. This is not to be confused with MPEG (Moving Pictures Experts Group), which is typically used for video streaming.

One aspect of data network to transport voice is a voice gateway. A voice gateway is a device that receives traditional telephony signals and converts them into digital data and then packetizes the data for transport over the network and de-packetization and reconversion on the other end. One embodiment of this invention is a ‘video gateway’ that provides the same capability for video surveillance networks.

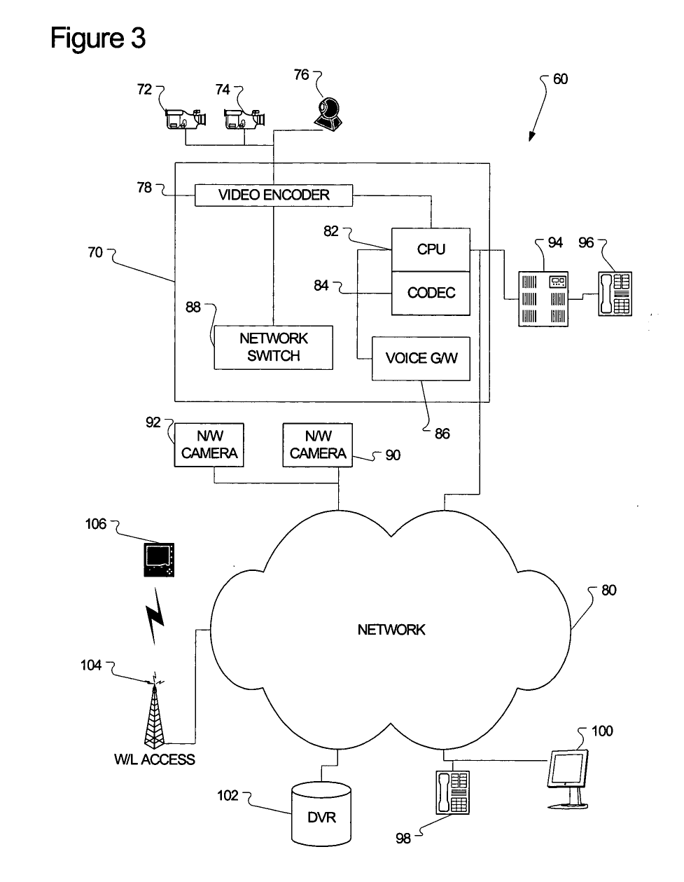

It is already possible to transport video data across networks, using such protocols as the International Telecommunications Union (ITU) standard H.323. However, this protocol assumes that the video data is in a ‘moving picture’ format, such as MPEG, and that the equipment is capable of producing the video data in the appropriate form. A video gateway will provide a greater intelligence than currently available to network-capable cameras and video servers, without requiring specialized equipment to replace them, as well as allowing telephone-like access to the video feeds from the cameras, making the network far more efficient and flexible. A video surveillance network including such a gateway is shown in FIG. 3.

The video gateway 70 resides in a combined network 60. The combined network is one that combines video surveillance feeds, voice calls, and data, or at least two of the three. The video gateway 70 receives image feeds from any combination of network-capable cameras such as 90 and 92, and analog cameras 72 and 74, and PTZ cameras such as 76. The network-capable cameras 92 and 90 may be simple devices that are made more intelligent when used in conjunction with the video gateway 70. The network switch, such as a LAN card/Ethernet card, 88, allows the cameras to communicate in a more intelligent fashion through the network 80. The analog and PTZ cameras interact with the network through the video encoder 78 included in the gateway.

The processor 82, which may be a general-purpose processor or a digital signal processor (DSP), may also be referred to as a central processing unit (CPU). The CPU 72 provides the cameras with increase abilities to interact with the network, as will be discussed below. In addition, a coder/decoder (codec) 84 may be included in the processor, or may be a dedicated chip. The codec would allow the MJPEG or JPEG data from the cameras and allow it to be transcoded into MPEG 2-4, H.263 or H.264 video streams, allowing other devices, such as video phones, personal digital assistants, and personal computers to view the video stream.

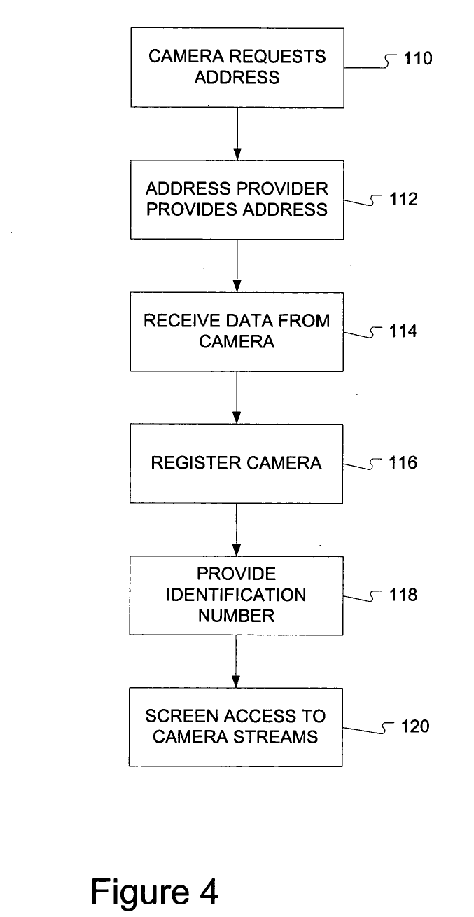

The video gateway may have control over the network-capable cameras. As will be discussed with regard to FIG. 4, the cameras undergo a registration procedure that allows the video gateway to have control over the cameras. This allows the gateway to set the configuration parameters such as the network address of the DVR, which may be an IP address, the framing rate, the encoding mechanism, etc. The video gateway will also support the signaling protocols, such as H.323, SIP, and Skinny (Skinny Reliable Transport Protocol) for the transport of switched video calls over the network. The combination of control and signaling capabilities allow the dynamic/signaled access to the video surveillance devices.

In addition, if the video gateway were being used in conjunction with a voice over data networks implementation, the video gateway 70 may include a voice gateway 86. The voice gateway may have a voice network device such as a hub or private-branch exchange (PBX) 94, and a number of phones such as 96 in communication with it.

Referring now to FIG. 4, the registration and management of the video network are discussed. At 110, the network-capable camera is initialized and contacts an address provider, such as a dynamic host configuration protocol (DHCP) server, or SIP proxy server. The address provider provides a network address, such as an IP address, to the camera and directs it to send its data to the video gateway at 112. Referring back to FIG. 3, the camera would be 92 and the video gateway would be 70. The address provider may reside on the network 80, or it may reside in the video gateway. The cameras may have their own connection to the network 60.

Once the video gateway 70 begins receiving the data from the camera at 114, the video gateway registers the camera 116. This may involve registering a dial plan for the camera under H.323, or a registration request under SIP. Some network-capable cameras support DHCP, but none of them support registration. Once the video gateway registers the camera at 114, it provides identification numbers for the cameras at 118. This may be akin to a telephone number, such that a user on the network may ‘dial’ the camera and access its image stream from across the network. Alternatively, or in addition, the camera may be provided an IP address or alias to allow other devices on the network to identify and communicate with the camera. If the video gateway is also functioning as a voice gateway, phone numbers for the phones using the gateway will also be registered.

With the increase intelligence in the video gateway, it is possible to control access to the video stream. For example, only members of a particular group, such as a closed users group (CUG), may be allowed to access the video from a particular camera. A user that is a member of the group, such as security personnel or the facility manager may be granted access, either by user identification/password, or identification of a calling unit.

Returning to FIG. 3, the video gateway has at least one interface that allows it to communicate with the cameras, such as the network switch 88. In addition, there is another interface 108 that allows the device to communicate with the network 80. This may be the same network switch 88, or may be another means of access.

With the increase capabilities provided by the video gateway, it is possible for other devices on the network to directly contact the camera and allow the video stream to be accessed. Access may include viewing the stream, such as on monitor 100, or accessing the stream for storage, such as by DVR 102. As mentioned previously, a user could use a telephone, such as video phone 98, to access the video stream from anywhere on the network.

For some applications, it may be desirable for a user to access a camera in a wireless fashion. For example, security personnel on foot patrol may desire to view a stream from a camera across the facility. They may be granted wireless access from a wireless device such as a wireless-equipped personal digital assistant (PDA) 106, through a wireless access point 104. The access will more than likely be secured and authenticated, such as through encryption, etc., to ensure that the video stream is not susceptible to hijack or hacking.

In addition, the video gateway may provide the ability to change the configuration or operation of the cameras via other devices on the network. Pan/tilt/zoom control may be enabled through a user interface provided via a web interface, or through a phone keypad, where a particular number may correspond to a command, such a pan right, pan left, tilt up, tilt down, zoom in, zoom out, etc.

Thus, although there has been described to this point a particular embodiment for a method and apparatus to provide a video surveillance network using a data network, it is not intended that such specific references be considered as limitations upon the scope of this invention except in-so-far as set forth in the following claims.

What is claimed is:

1. A network device, comprising:
a first interface to allow communication with at least one network-capable camera;
a second interface to allow communication with a network; and
a processor to:
receive video data from the network-capable camera;
allow the device to communicate the video data to a network; and
receive commands for the camera from the network and communicate them from the network.

2. The network device of claim 1, the network device further comprising a video encoder to receive video data from at least one network-incapable camera and encode it for use by the processor.

3. The network device of claim 1, the network device further comprising a dynamic host configuration protocol server.

4. The network device of claim 1, the network device further comprising a gatekeeper in accordance with the International Telecommunications Union standard H.323.

5. The network device of claim 1, the network device further comprising a session initiation protocol proxy server.

6. The network device of claim 1, the network device further comprising a voice gateway.

7. The network device of claim 1, the processor further to receive commands and to provide the commands to the camera for camera operations.

8. A method of managing a video surveillance data network, comprising:
receiving data from a network-capable camera;
registering the camera with a network management device;
providing an identification number for the camera;
transmitting video data from the camera across a network;
screening requests for communication with the camera to only allow authorized users to access data from the camera.

9. The method of claim 8, the method further comprising registering telephone numbers for voice-over data network calls.

10. The method of claim 8, registering the camera with a network management device further comprising registering the camera with a gatekeeper.

11. The method of claim 8, registering the camera with a network management device further comprising registering the camera with a session initiation protocol proxy server.

12. The method of claim 8, providing an identification number for the camera further comprising providing a telephone number for the camera.

13. The method of claim 8, providing an identification number for the camera further comprising providing a network address for the camera.

14. The method of claim 8, transmitting video data from the camera across a network further comprising transmitting video data from the camera to a digital video recorder across the network.

15. The method of claim 8, screening requests for communication with the camera further comprising only allowing members of a closed users group to communicate with the camera.

16. A network device, comprising:
means for allowing communication with at least one network-capable camera;
means for allowing communication with a network; and
means for:
receiving video data from the network-capable camera;
allowing the device to communicate the video data to a network; and
receiving commands for the camera from the network and communicate them from the network.

17. The network device of claim 16, the network device further comprising means for receiving video data from at least one network-incapable camera and encoding it for use by the processor.

18. An article of machine-readable code containing instructions that, when executed, cause the machine to:
receive data from a network-capable camera;
register the camera with a network management device;
provide an identification number for the camera;
transmit video data from the camera across a network;
screen requests for communication with the camera to only allow authorized users to access data from the camera.

19. The method of claim 18, the instructions, when executed, further causing the machine to register telephone numbers for voice-over data network calls.

20. A video surveillance network, comprising:
at least one network-capable camera;
at least one network phone;
at least one network device to:
receive video data from the camera and transmit it across the network;
receive voice data from the network phone and transmit it across the network; and
at least one video monitor to allow viewing of the video data transmitted across the network.

21. The video surveillance network of claim 20, further comprising a digital video recorder to store the video data.

22. The video surveillance network of claim 20, the network device to provide access to the video data to approved users.

23. The video surveillance network of claim 20, further comprising at least one wireless access point to allow access to the video data from a wireless device.
